(19) United States
(12) Patent Application Publication
(10) Pub. No.: US 2004/0167827 A1
(43) Pub. Date: Aug. 26, 2004

(54) Method and system for conducting business transactions through multiple and diverse distribution and product order channels

(76) Inventors: Christine S. Vincent, Greer, SC (US); Richard E. Philo, Simpsonville, SC (US)

Correspondence Address: Nexsen Pruet Adams Kleemeier LLC, PO Box 10648, Greenville, SC, 29603, US

(21) Appl. No.: 10/790,565

(22) Filed: Mar. 1, 2004

Related U.S. Application Data
(62) Division of application No. 09/853,240, filed on May 11, 2001.

(51) Int. Cl. G06F 17/60

(52) U.S. Cl. 705/26

(57) ABSTRACT

A system, and method, for coordinating product orders and distribution over a network is described wherein a manufacturer and a customer have a specific contractual price relationship. The system comprises a communication device for receiving a manufacturing specific order over the network from an exchange where the manufacturing specific order comprises a product identifier, which identifies a product of the manufacturer. The manufacturing specific order also comprises, a product volume and a customer identifier which identifies the customer. A second communication device transmits a product availability request to a dealer wherein the product availability request comprises the product identifier and the product volume. A third communication device receives an availability report from the dealer wherein the availability report comprises a dealer availability index for the product and a dealer price adjustment. A processor determines a customer price from the contractual price relationship and the dealer price adjustment and an availability index derived from the dealer availability index and a manufacturers inventory. A fourth communication device transmits a manufacturer confirmation report to the exchange wherein the manufacturer confirmation report comprises the customer price and the availability index. A fifth communication device receives a purchase order from the exchange wherein the purchase order comprises products distributed by the dealer. A sixth communication device transmits a dealer purchase order to the dealer wherein the dealer purchase order comprises the products distributed by the dealer.

### TECHNICAL FIELD

The present invention is related to a method and system for order and delivery of products through networks with control features for product selection, product order, product delivery and reporting through a diverse group of manufacturing and distribution channels.

### BACKGROUND

It is a common practice in the industry to utilize intermediate dealers to distribute products from a manufacturer to an end customer. In one common model, a dealer, or retailer, purchases products directly from a manufacturer to create an inventory and the inventory is depleted as the product is purchased from customers. This type of arrangement, referred to herein as “retailer arrangement” works well when the end customer and manufacturer have no direct arrangement except for that which conduits through the dealer.

In the medical supply industry it has become common practice for a medical device manufacturer to develop a contracted relationship with an end customer, such as a hospital or purchasing group, to supply certain products used by the end customer. While direct shipping would be possible it duplicates a distribution chain currently in place which utilizes independent dealers strategically located by market conditions. For example, if a manufacturer wished to distribute a product to an end user in one region it would require a shipping cost from the manufacturers distribution port to the end customers receiving port. At the same time, a dealer may have the same product in the same region as the end customer and could therefore distribute the product for minimal shipping cost and in less time. The dealer also adds value by assisting in installation and service. Therefore, it is of interest to utilize an independent dealer network while still allowing the flexibility of direct contracted arrangements between the end customer and manufacturer.

Presently, the medical supply industry sells and distributes products as shown in FIG. 1. In FIG. 1, the manufacturers are indicated as M¹, M² and M³. Customers are indicated as C¹ and C² and the dealer is indicated as D¹. The illustration in FIG. 1 comprises one dealer which has a distribution relationship with three manufacturers to two customers. While illustrative, it is understood that there are many dealers associated with many manufacturers and with many customers and that a manufacturer or customer may have relationships with multiple dealers.

In standard practice, and by way of illustration, manufacturer, M¹, may have a contracted pricing arrangement with a customer, C¹, as indicated at 100. The contracted pricing arrangement may comprise terms which correlate price to volume, percentage use, and compliance with contracted terms. For example, if customer C¹ utilizes 100% of a particular product from manufacturer M¹ the price may be adjusted downward whereas if only 75% of a particular product is purchased from manufacturer M¹ and 25% from manufacturer M² or M³ the price may be adjusted upward. In standard practice customer C¹ orders direct from dealer, D¹, as indicated at 200. The dealer delivers the product at 201 and payment is made to the dealer at 202. After receiving and fulfilling the order dealer D¹ reports the transaction to the manufacturer M¹ at 300 and compensation is made between the dealer D¹ and manufacturer M¹ at 301 in accordance with prearranged compensation schedules.

Even in an isolated illustration as presented in relation to FIG. 1, the current system is complicated by various problems which are known to exist. The dealer may not be privy to the contracted arrangement between the manufacturer and customer. In practice any contractual relationship between manufacturers and customers may be proprietary. The relationship between manufacturers and dealers is also typically proprietary and may involve additional services and products not offered by manufacturer M¹. Therefore, manufacturer M¹ may receive a report concerning the amount of a specific product delivered by dealer D¹ to customer C¹ but the amount of an equivalent product manufactured by M² and supplied by D¹ would be unavailable. It is conceivable that communication inefficiencies or communication gaps could incorrectly indicate that a particular customer was compliant with a manufacturer thereby the manufacturer would receive a lower price while the dealer receives the higher price anticipated to be paid by the customer. Therefore, manufacture M¹ may have no way to monitor the degree of compliance and the dealer may have no way to correctly report compliance without breech of a collateral agreement. Therefore, pricing structure is convoluted and confused due to partial reporting throughout the entire cycle of transactions. In the past the pricing structure has been resolved by standard accounting type audits which are an expense and the problem is exasperated by the large number of dealers and end customers and manufacturers. Further complicating the current system is the presence of group purchasing organizations (GPO) which may enter into contract with a customer, a manufacturer, and possibly a dealer to take advantage of volume discounts. For example, a GPO may enter into a purchasing agreement with a manufacturer to supply products to member customers who reside in vastly different geographic regions thereby requiring different dealers for product supply. For the purposes of the present invention the customer can refer to a single entity, a consortium of entities or an entity which is a member of a consortium.

Yet another problem occurs with inventory coordination. For example, each manufacturer preferably ships products directly to a dealer for warehousing and rapid order fulfillment of customer orders. If an order comes to the dealer which exceeds the dealers supply the dealer must first request additional product from the manufacturer prior to fulfillment of the order. It is often more feasible to enlist the services of a second dealer, or to transport product directly to the customer from the manufacturer. For customer relations purposes it is most desired that the customer not be encumbered with the details of where product is arriving from thereby making the arrangement seamless from the customers perspective. Under the current model, as described relative to FIG. 1, this is complicated by the fact that the customer may compensate the manufacturer directly which results in multiple bills for the customer and multiple revenue streams for the manufacturer with the multiple revenue streams originating from the same customer. These multiple revenue streams must be merged for accurate accounting of products purchased particularly if incentives, or rebates, are provided. Alternatively, the customer may compensate the dealer directly yet the dealer may have no information regarding product which was shipped directly. The reporting becomes fragmented and errors in recording occur.

Efforts to resolve the product distribution scheme described above have created even further problems. For example, removing the dealer and shipping directly from the manufacturer requires distribution networks to be established which are less efficient and cost prohibitive. Direct reporting from the customer places additional burdens on the customer which is unacceptable in light of constant pressures to reduce cost. Requesting additional information from dealers, such as total product shipped to a customer from all manufacturers, is contrary to contractual relationships between dealers and manufacturers specifically with respect to the proprietary nature of the information.

This long standing problem in the art has yet to be resolved prior to the present invention.

### SUMMARY

It is an object of the present invention to provide a system for ordering products electronically over the internet while taking advantage of the placement of third party distributors.

It has been a further object of the present invention to allow a manufacturer and customer to enter into a proprietary pricing contract while still allowing regional and local distributor dealers to supply product without breeching the proprietary pricing relationship or displacing the distributor dealer.

It has been a further object of the present invention to provide the system as an internet based application thereby reducing the time between transactions and reducing the necessity for financial audits.

A particular feature of the present invention is the flexibility of being capable of integrating direct delivery from the manufacturer to the customer and indirect delivery through a dealer in one system.

Another particular feature is the ability to combine direct and indirect delivery while still maintaining simplicity for the customer, manufacturer and dealer.

Yet another feature of the present invention is the ability of the customer to have visibility of the manufacturers and dealers inventory. This is particularly advantageous when the dealers inventory comprises products from multiple manufacturers. Furthermore, the manufacturer and dealer can have visibility of inventory throughout the diverse supply chain.

Another particular feature of the present invention is the ability of the manufacturer to maintain visibility of product inquiries, orders and deliveries without relying on dealer, or third party, reports.

These and other advantages, as will be realized, are provided in a method for electronic commerce over a network. The method comprises the steps:transmitting an order entry data set from a customer to an exchange wherein the order entry data set comprises a product identifier and a product volume; determining a manufacturer from the product identifier; transmitting a manufacturer specific order from the exchange to the manufacturer wherein the manufacturer specific order comprises the product identifier and the product volume; transmitting a product availability request from the manufacturer to a dealer wherein the product availability request comprises the product identifier and the product volume; transmitting an availability report from the dealer to the manufacturer wherein the availability report comprises a dealer price adjustment; transmitting a manufacturer confirmation report from the manufacturer to the exchange wherein the manufacturer confirmation report comprises an availability index derived from the availability report and a customer price derived from the dealer price adjustment; transmitting a product order confirmation from the exchange to the customer wherein the product order confirmation comprises the manufacturers confirmation report; transporting a product corresponding to the product identifier from the dealer to the customer; transferring purchase funds from the customer to the dealer wherein the purchase funds correspond to the customer price; and transferring manufacturer funds from the dealer to the manufacturer

Yet another embodiment is provided in a system for coordinating product orders and distribution over a network wherein a manufacturer and a customer have a specific contractual price relationship. The system comprises a communication device for receiving a manufacturing specific order over the network from an exchange where the manufacturing specific order comprises a product identifier, which identifies a product of the manufacturer. The manufacturing specific order also comprises, a product volume and a customer identifier which identifies the customer. A second communication device transmits a product availability request to a dealer wherein the product availability request comprises the product identifier and the product volume. A third communication device receives an availability report from the dealer wherein the availability report comprises a dealer availability index for the product and a dealer price adjustment. A processor determines a customer price from the contractual price relationship and the dealer price adjustment and an availability index derived from the dealer availability index and a manufacturers inventory. A fourth communication device transmits a manufacturer confirmation report to the exchange wherein the manufacturer confirmation report comprises the customer price and the availability index. A fifth communication device receives a purchase order from the exchange wherein the purchase order comprises products distributed by the dealer. A sixth communication device optionally transmits a dealer purchase order to the dealer wherein the dealer purchase order comprises the products distributed by the dealer.

A further embodiment is provided in a system for coordinating product orders and distribution over a network. The system comprises a multiplicity of manufacturers, a multiplicity of customers and a multiplicity of dealers. At least one manufacturer of the multiplicity of manufacturers and at least one customer of the multiplicity of customers have a specific contractual price relationship. The system comprises a communication device for receiving an order entry data set from the customer wherein the order entry data set comprises at least one product identifier identifying a product manufactured by the manufacturer and at least one product volume and at least one customer identifier. The communication device further transmits a manufacturer specific order to the manufacturer wherein the manufacturer specific order comprises the product identifier, the product volume and the client identifier. The communication device further receives a manufacturers confirmation report from the manufacturer wherein the manufacturers confirmation report comprises an availability index for the product and a customer price wherein the availability index is derived from a dealer availability index and the customer price is derived from a dealer price adjustment and the specific contractual price relationship. The communication device further transmits a purchase order confirmation to the customer wherein the purchase order confirmation comprises the customer price and the availability index.

Yet another embodiment is provided in a method for coordinating product orders and distribution over a network. The network comprises a multiplicity of manufacturers, a multiplicity of customers and a multiplicity of dealers. Furthermore, at least one manufacturer of the multiplicity of manufacturers has a specific contractual price relationship with at least one customer of the multiplicity of customers. The method comprises:

a) receiving an order entry data set from the customer wherein the order entry data set comprises a product identifier identifying a product manufactured by the manufacturer and a volume and a customer identifier and a second product identifier and a second product volume identifying a second product manufactured by a second manufacturer and wherein the second manufacturer has a second specific price relationship with a second customer;

b) transmitting a manufacturer specific order to the manufacturer wherein the manufacturer specific order comprises the product identifier, the product volume and the client identifier;

c) transmitting a second manufacturers specific order to the second manufacturer wherein the second manufacturer specific order comprises a second product identifier and a second product volume and the customer identifier;

d) receiving a manufacturers confirmation report from the manufacturer wherein the manufacturers confirmation report comprises an availability index for the product and a customer price and wherein the availability index is derived from a dealer availability index and the customer price is derived from a dealer price adjustment and the specific contractual price relationship;

e) receiving a second manufacturers confirmation report from the second manufacturer wherein the second manufacturers confirmation report comprises a second availability index for a second product and a second customer price wherein the second availability index is derived from a second dealer availability index and a second customer price is derived from a second dealer price adjustment and the second specific contractual price relationship; and

f) transmitting a purchase order confirmation to the customer wherein the purchase order confirmation comprises the customer price, the availability index the second customer price and the second availability index.

A particularly preferred embodiment is provided in a system for coordinating product orders and distribution over a network wherein a manufacturer and a customer have a specific contractual price relationship. The system comprises a communication device for receiving a manufacturing specific order over the network from an exchange where the manufacturing specific order comprises a product identifier, which identifies a product of the manufacturer, a product volume and a customer indentifier which identifies the customer. The communication device further transmits a product availability request to a dealer wherein the product availability request comprises the product identifier the product volume and the customer identifier. The communication device further receives an availability report from the dealer wherein the availability report comprises a dealer availability index for the product and a dealer price adjustment. A processor is provided for determining a customer price from the contractual price relationship and the dealer price adjustment and an availability index from the dealer availability index and manufacturers inventory. The communication device further transmits a manufacturer confirmation report to the exchange wherein the manufacturer confirmation report comprises the customer price and the availability index. The communication device further receives a purchase confirmation from the exchange wherein the purchase confirmation comprises products distributed by the dealer. The communication device may optionally transmit a dealer purchase order to the dealer wherein the dealer purchase order comprises the products distributed by the dealer.

Yet another preferred embodiment is provided in a system for coordinating product orders and distribution over a network. The system comprises a multiplicity of manufacturers, a multiplicity of customers and a multiplicity of dealers and at least one manufacturer of the multiplicity of manufacturers and at least one customer of the multiplicity of customers have a specific contractual price relationship. The system comprises a communication device for receiving an order entry data set from the customer wherein the order entry data set comprises at least one product identifier identifying a product manufactured by the manufacturer and at least one product volume and at least one customer identifier. The communication device further transmits a manufacturer specific order to the manufacturer wherein the manufacturer specific order comprises the product identifier, the product volume and the client identifier. The communication device further receives a manufacturers confirmation report from the manufacturer wherein the manufacturers confirmation report comprises an availability index for the product and a customer price wherein the availability index is derived from a dealer availability index and the customer price is derived from a dealer price adjustment and the specific contractual price relationship. The communication device further receives a purchase order from the customer. The communication device further transmits a purchase order confirmation to the customer wherein the purchase order confirmation comprises the customer price and the availability index.

Yet another preferred embodiment is provided in a method for coordinating product orders and distribution over a network wherein a manufacturer and a customer have a specific contractual price relationship. The method comprises the steps:

a) receiving a manufacturing specific order over the network from an exchange where the manufacturing specific order comprises a product identifier, which identifies a product of the manufacturer, a product volume and a customer identifier which identifies the customer;

b) transmitting a product availability request to a dealer wherein the product availability request comprises the product identifier the product volume and the customer identifier;

c) receiving an availability report from the dealer wherein the availability report comprises a dealer availability index for the product and a dealer price adjustment;

d) determining a customer price from the contractual price relationship and the dealer price adjustment and an availability index from the dealer availability index and a manufacturers inventory;

e) transmitting a manufacturer confirmation report to the exchange wherein the manufacturer confirmation report comprises the customer price and the availability index;

f) receiving a purchase confirmation from the exchange wherein the purchase confirmation comprises products distributed by the dealer.

Yet another preferred embodiment is provided in a method for coordinating product orders and distribution over a network. The network comprises a multiplicity of manufacturers, a multiplicity of customers and a multiplicity of dealers and at least one manufacturer of the multiplicity of manufacturers and at least one customer of the multiplicity of customers have a specific contractual price relationship. The method comprises the following steps:

a) receiving an order entry data set from the customer wherein the order entry data set comprises at least one product identifier identifying a product manufactured by the manufacturer and at least one product volume and at least one customer identifier;

b) transmitting a manufacturer specific order to the manufacturer wherein the manufacturer specific order comprises the product identifier, the product volume and the client identifier;

c) receiving a manufacturers confirmation report from the manufacturer wherein the manufacturers confirmation report comprises an availability index for the product and a customer price wherein the availability index is derived from a dealer availability index and the customer price is derived from a dealer price adjustment and the specific contractual price relationship;

d) receiving a purchase order from the customer; and

e) transmitting a purchase order confirmation to the customer wherein the purchase order confirmation comprises the customer price and the availability index.

### BRIEF DESCRIPTION OF THE DRAWINGS

FIG. 1 is a flowchart illustrating the prior art method of product procurement and delivery prior to the present invention.

FIG. 2 is an embodiment of the present invention, in flowchart form, illustrating the flow of information and product in the present invention.

FIG. 3 is a flow chart illustrating a preferred embodiment of the product availability procedure of the present invention.

FIG. 4 is a flow chart illustrating a preferred embodiment of the order process of the present invention.

FIG. 5 is a diagrammatic representation of an embodiment of the system of the present invention.

FIG. 6 is a diagrammatic representation of the system of the present invention.

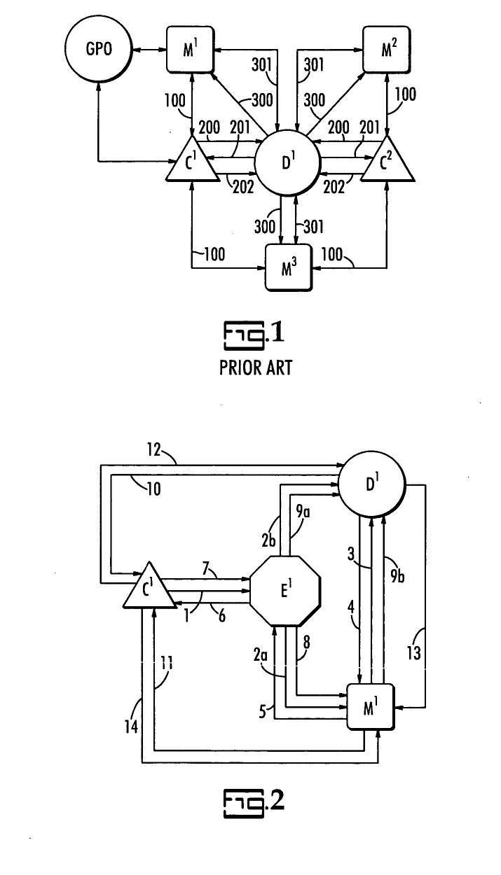

### DETAILED DESCRIPTION

The invention will be described with reference to the drawings wherein similar elements are numbered accordingly.

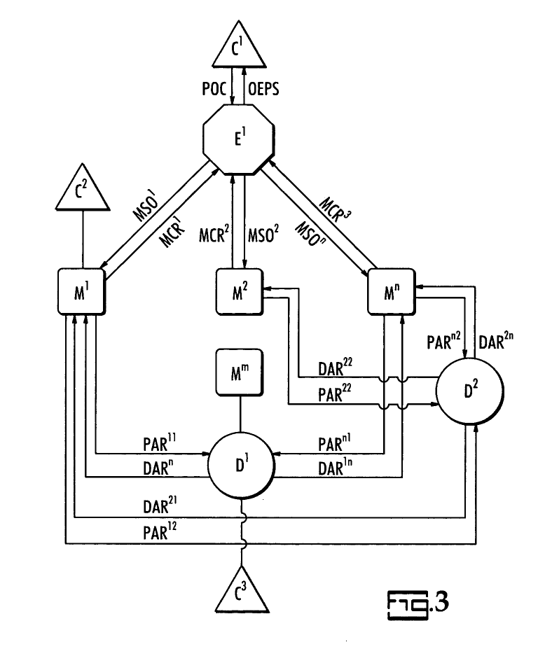

An embodiment of the present invention will be described with reference to FIG. 2 wherein a preferred order entry and placement method is described. In FIG. 2 a single customer, C¹, communicates with an exchange, E¹. The exchange communicates with a manufacturer, M¹, and dealer, D¹. It would be understood that multiple customers, exchanges, dealers and manufacturers could be incorporated in the model. The embodiment illustrated in FIG. 2 is provided for clarity.

In FIG. 2, a customer, C¹, places an order entry data set (OEDS), 1, over a network to an exchange, E¹. The OEDS, 1, comprises a customer identifier (CI), product identifier (PI), and product volume (PV). The exchange, E¹, determines the product manufacturer from the PI and transmits a manufacturer specific order (MSO), 2a, through a network to the manufacturer, M¹. The MSO comprises the PI and PV of those products listed in the OEDS which are manufactured by manufacturer, M¹, and preferably a customer identifier (CI). Manufacturer, M¹, transmits a product availability request (PAR), 3, to the dealer, D¹, wherein the PAR comprises a PI, PV and preferably CI. Based on the ability of the dealer, D¹, to supply the requested product, a dealer availability report (DAR), 4, is sent from the dealer, D¹, to the manufacturer, M¹. The DAR, 4, comprises a dealer availability index (DAI) which may comprise an affirmation, a percentage available or a date available. The DAI may also comprise a dealer price adjustment (DPA) which may include shipping cost, set up cost, service cost, rebate or coupon credits, or other differentials to the price independently negotiated between the dealer, D¹, and the customer, C¹. The manufacturer determines a customer price (CP) based on the DPA and the contracted price between the customer and the manufacturer, and an availability location for the product and creates an availability report comprising the customer price and availability index (AI). The availability index is derived from the DAI. If the DAI indicates that the complete order can be fulfilled by dealer D¹, the AI may only indicate that product is available for delivery. If the DAI indicates that the order can be partially filled by dealer D¹ the manufacturer, M¹, may supply the customer directly or may supply all of part of the product from a second dealer. In the case of partial shipment, the AI may indicate that the order will be fulfilled in two parts or it may indicate that a product, or part of a product, is backordered and will be shipped separately. The manufacturer, M¹, transmits the manufacturers confirmation report (MCR), 5, to the exchange, E¹ over a network. The MCR comprises the AI and CP. The exchange, E¹, transmits a product order confirmation (POC), 6, comprising the MCR. It would be apparent from the description that the OEDS, 1, may comprise product identifiers which identify products manufactured by a second manufacturer other than M¹. In this instance, the POC, 6, would include an additional MCR from the second manufacturer.

After receiving the POC, 6, the customer, C¹, transmits a purchase order (PO), 7, to the exchange, E¹. The exchange transmits a purchase confirmation (PC), 8, comprising the MSO to the manufacturer, M¹. The exchange, E¹, preferably transmits a dealer purchase order (DPO), 9a, directly to the dealer, D¹, and the dealer transmits the appropriate product to the customer, 10. In another embodiment the exchange E¹ transmits a purchase confirmation, 8, to the manufacturer and the manufacturer transmits the DPO to the dealer, 9b. The customer, C¹, compensates the dealer, 12, and the dealer compensates the manufacturer, 13.

In an alternative embodiment, a dealer specific order (DSO), 2b, is transmitted from the exchange, E¹, directly to the dealer, D¹. The dealer, D¹, preferably transmits the DAR, 4, to the manufacturer, M¹, and the remaining sequence of transactional steps are followed as previously described.

In an alternate embodiment, the manufacturer, M¹, supplies the customer directly as indicated at 11. In this embodiment it is most preferred that the customer compensate the manufacturer directly for the product as indicated at 14.

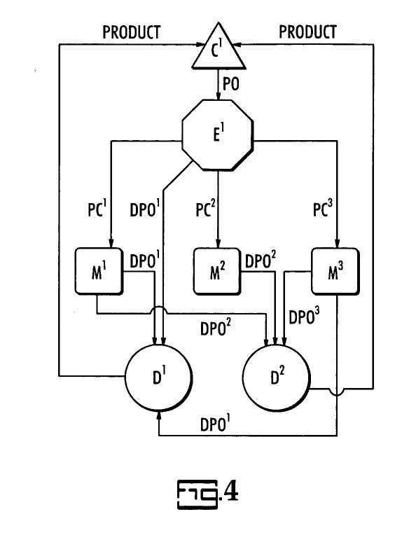

An embodiment of the product order method is illustrated in flow chart form in FIG. 3. In summary, a customer places an OEDS with the exchange, E¹. The exchange transmits a MSO to each appropriate manufacturer. The manufacturer transmits a PAR to each appropriate dealer. Each dealer responds to the manufacturer with a DAR. Each manufacturer then forwards an MCR to the exchange and a POC is transmitted to the customer.

The embodiment of FIG. 3 will be more fully described by the following example. The example is not limiting but is intended to illustrate the operation of the invention. In the example, the customer, C¹, orders five products with each product indicated by a product identifier PI^{a} and a product volume PV^{a} wherein superscript “a”0 indicates the manufacturer of the specific product. The OEDS would therefore contain five pairs of product identifiers and associated volumes. For the purposes of this illustration the OEDS would include two products manufactured by M¹ one of which is distributed by D¹ and one by D². The OEDS would also include one product manufactured by M² and distributed by D² and two products manufactured by Mⁿ with one distributed by D¹ and one by D². The exchange would send a manufacturer specific order, MSO^{a}, to each manufacturer wherein the superscript “a” identifies a particular manufacturer. Therefore, in the example, manufacturer M¹ would receive MSO¹, manufacturer M² would receive MSO² and manufacturer Mⁿ would receive MSOⁿ. Each manufacturer would transmit, over a network, a PAR^{ab} to the appropriate dealer where the superscript “a” indicates the manufacturer and the superscript “b” indicates the dealer. For example, manufacture M¹, would transmit PAR¹¹ to dealer D¹ which includes the PI and PV for products manufactured by M¹ and distributed by D¹. Likewise, M¹ would transmit PAR¹² to dealer D² which includes the PI and PV for products manufactured by M¹ and distributed by dealer D². In a similar fashion, manufacture M² would transmit PAR²² to dealer D² and manufacturer Mⁿ would transmit PARⁿ¹ to dealer D¹ and PARⁿ² to dealer D². The dealer determines the availability of each product in inventory and transmits, by a network, a DAR^{ab}, wherein superscript “a” indicates the dealer and superscript “b” indicates the manufacturer. Therefore, dealer D¹ transmits DAR¹¹ to M¹ and DAR¹ⁿ to Mⁿ. Likewise, dealer D² transmits, over a network, DAR²¹ to M¹, DAR²² to M² and DAR²ⁿ to Mⁿ. Each manufacturer prepares an MCR^{a} wherein the superscript “a” represents the manufacturer, and forwards the MCR^{a} to the exchange, E¹. In the example, M¹ transmits MCR¹, M² transmits MCR² and Mⁿ transmits MCRⁿ to the exchange, E¹, through a network. The exchange combines the MCR from the manufacturers and transmits, by a network, a POC which indicates product availability and customer price.

The advantages provided by the present invention are realized by further review of FIG. 3. In FIG. 3, manufacturer, M¹, may have a direct supply relationship with customer C². The customer, C², may provide an MSO directly to the manufacturer without employing the services of the exchange. In a similar fashion, customer C² may have a direct relationship with dealer, D1, wherein a DAR or DPO can be submitted directly and products from manufacturer M^{m} can be supplied without employing the services of the exchange. By allowing multiple points of entry the network is flexible and expandible.

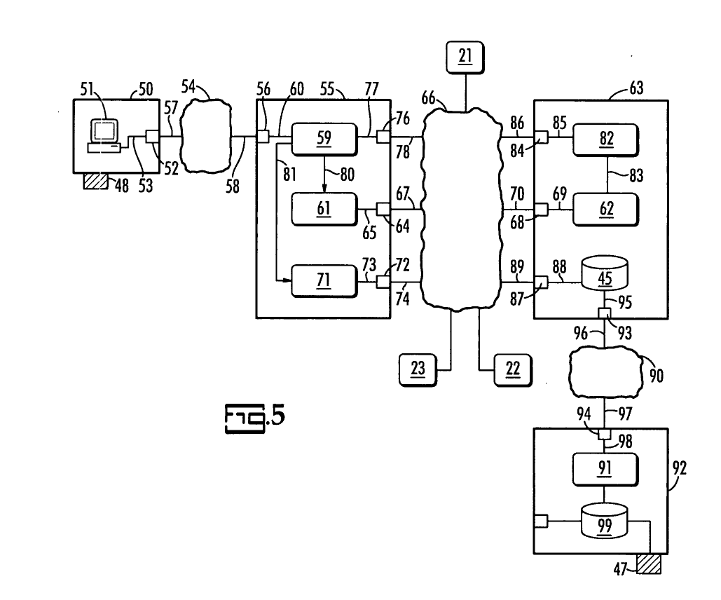

An embodiment of the product purchase and distribution is illustrated in FIG. 4. The customer, C¹, transmits a PO to the exchange, E¹. The PO preferably comprise the same elements as the EODS and POC described relative to FIG. 3 or it may be modified by deleting products or adding products. The exchange transmits, via a network, a PC^{a} wherein the superscript “a” indicates the manufacturer of the product. It would be apparent that the PC is a subset of the PO and that it is the subset of those products manufactured by a specific manufacturer. Continuing with the example set forth relative to FIG. 3 the exchange, E¹, transmits PC¹ to M¹, PC¹ to M² and PCⁿ to Mⁿ. In a particularly preferred embodiment, the exchange, E¹, transmits, via a network, a DPO^{ab} wherein the superscript “a” indicates the manufacturer and the superscript “b” indicates the dealer. In an alternate embodiment the manufacturer transmits the DPO^{ab} to the dealer. Therefore, E¹ or M¹ transmits DPO¹¹ and DPO¹² to D¹ and D² respectively. E¹ or M² transmits DPO²² to D². E¹ or Mⁿ transmits DPOⁿ¹ and DPOⁿ² to D¹ and D² respectively. Each dealer ships the appropriate products directly to the customer. In one embodiment of the present invention the manufacturer may automatically replenish the inventory of the dealer based on the product and volume shipped to the customer.

The embodiment described with reference to FIGS. 3 and 4 offers many advantages which are presently unavailable in the art. Specifically, the use of a network, such as the world wide web, allows the customer to enter only two commands. One command is for order availability and one for order purchasing. In a preferred embodiment, the customer only enters a purchase order and therefore, one command initiates receipt of products. In a particularly preferred embodiment automatic ordering can be accomplished wherein computer-to-computer communications utilized. The is particularly advantages where inventory levels are monitored automatically and product orders initiated automatically based on the inventory levels. In this embodiment the customer may not have a human interface initiating the order. The customer can order from any manufacturer, or dealer, on the network without sorting through multiple catalogs, online or otherwise, to determine which products are needed. This is all done without requiring a one-to-one customer order relationship that currently exist in network based transactions. A manufacturer may still offer preferential pricing for high volume customers without eliminating the advantages offered by intermediate parties such as a dealer. Furthermore, any contracted price between the manufacturer and the customer is confidential with the exception of the exchange yet the information does not reach other manufacturers or customers. Accountability is enhanced since the manufacturer monitors each transaction and where it is sent which virtually eliminates the reporting currently necessary between dealers and manufacturers since all product transmitted by a dealer through the network is monitored. Another advantage is the ability for this invention to augment the current business model since those transactions that are directly between the customer and the dealer would not be altered.

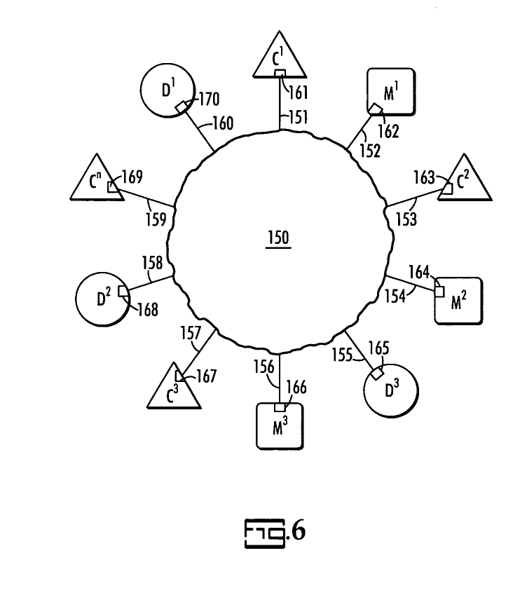

An embodiment of the system for product order and delivery is illustrated in FIG. 5. In FIG. 5, a customer, 50, comprises a computer, 51, wherein communications are initiated. The computer, 51, is connected to a communication device, 52, by a data link, 53. The communication device allows computer generated information to be transmitted and received over a network, 54, such as the world wide web, by a data link, 57. The exchange, 55, also comprising a communication device, 56, connected to the network, 54, by a data link, 58, receives information, such as an OEDS or PO, from the customer, 50, and transmits information, such as a POC, to the computer, 51, of the customer, 50. A router, 59, in communication with the communication device, 56, by a data link, 60, receives a request to view products and descriptions, or a request to purchase products from the customer.

A particular feature is further illustrated in FIG. 5. A customer, 21, manufacturer, 22, or dealer, 23, can access the network directly with, or without enlisting the services of the exchange and without decreasing the effectiveness of the network. For example, customer, 21, could directly access the inventory of the manufacturer, 63, and the dealer 92, if proper security levels were utilized. By allowing for multiple points of access the network can be expanded without departing from the advantages offered thereby.

If a request to view products is received the customer is allowed to view a basic catalog stored in a basic catalog server, 61, which is in communication with the router, 59, via a data link, 80. The customer is then able to view the data stored in the basic catalog server, 61, as is common in network based data base viewing. The manufacturer, 63, comprises a content rich catalog server, 62, within which further information regarding products and product specifications is stored to augment and supplement the basic catalog server, 61. If further information is desired by the customer than that available in the basic catalog server, 61, the customer can request further information preferably by clicking on an icon at computer, 51, with a selector such as a mouse, as known in the art, wherein access to a content-rich catalog server, 62, of the manufacturer, 63, is accessed. The basic catalog server, 61, is connected to a communication device, 64, by a data link, 65. The communication device is also connected to a network, 66, by a data link, 67. The content rich catalog server, 62, is also connected to a communication device, 68, by a data link, 69, which allows information to be transmitted over the network, 66, through a data link, 70. If products are selected by the customer from the content rich catalog server, 62, the information is transferred to a shopping cart, 82, via a data link, 83. The information is collected in the shopping cart, 82, and transmitted to the router, 59, via a communication device, 84, and associated data links, 85 and 86, to the network, 66. The customer can therefore view contents in a basic catalog server, 61, or a content rich catalog server, 62, or dealer database, 91, without ceasing communication with the exchange. Furthermore, selections can be made from among the products stored on the basic catalog server, 61, the content rich catalog server, 62, or other catalogs on the network as would be apparent from further descriptions. A single source supply can be artificially created without depleting the ability of the manufacturer to separately enter in pricing structures with the customer. This is often referred to as a round-trip. After collection of the PI and PV are complete an MSO is transmitted from the purchase order processor, 71, to the order database, 45, over network, 66, via communication devices, 87 and 72 and associated data links. A DSO is transmitted from the order database, 45, to a dealer database, 91, through a network, 90, via communication devices, 93 and 94 and associated data links. A DAR is them transmitted back to the order database, 45. The DAR is converted into an MCR for transmittal to the purchase order processor, 71. A POC is then transmitted to the customer.

If a purchase order is received from the customer without the necessity of reviewing the catalog the purchase order is transmitted directly to a purchase order processor, 71, via a data link, 81, for determination of the manufacturer of the product and for preparation of an MSO as previously described herein. The router, 59, is further in communication with a network, 66, by connection with a communication device, 76, and associated linkages, 77 and 78. The purchase order processor, 71, is connected to a communication device, 72, by a data link, 73, which is further in communication with the network, 66, by a data link, 74.

After completion of the product selection process and receipt of a POC the customer transmits a PO from computer, 51, to server, 59, via the network, 54, utilizing communication devices, 52 and 56 and associated data links. The PO is transmitted from the server, 59, to the purchase order processor, 71, via data link, 81. The purchase order processor transmits an MSO through a communication device, 72, and associated data link, 73, to the network, 66, via data link, 74. The order database, 45, of the manufacturer, 63, receives the MSO via communication device, 87, and associated data links, 88 and 89, via the network, 66. The order database, 86, transmits the DSO via a network, 90, to a dealer database, 91, of the dealer, 92, via communication devices, 93 and 94, and data linkages, 95-98. Once the order is placed the DPO is transmitted from the dealer database, 91, to a order fulfillment system, 99, wherein the product is transferred to a shipping element, 47, and the product is transferred to a receiving element, 48, of the customer.

It would be apparent to one of ordinary skill in the art that the elements recited in reference to FIG. 5 are for the purposes of illustration and other embodiments, and consolidations, may be employed without departing from the scope. It is preferred that the networks, 54, 66 and 90 are one network and more preferably the network is the world wide web. The individual elements within the exchange may be consolidated into a single component with each function performed by a portion of the single component. Likewise, the exchange may have a single communication device for communication to both the customer and the manufacturer or the exchange may rely on redundant devices as would be realized by one of ordinary skill in the art. The manufacturer may also rely on a single component to perform the functions recited wherein the single component performs all functions of the elements called out separately in FIG. 5 and the discussion associated therewith.

An embodiment of the present invention is illustrated in FIG. 6 wherein multiple dealers, multiple manufacturers and multiple customers all communicate through a network, 150, via communication links, 151-160 and communication devices 161-170. Each individual can be addressed by each other individual preferably utilizing uniform resource locator (URL) codes as known in the art of network communication.

The term “network” as used herein refers specifically to a computer network. Computer networks, broadly speaking are a set of communication devices, or nodes, and communication links which interconnect the communication devices using standard protocols such as Hypertext Transport Protocol (HTTP) and Transmission Control Protocol/Internet Protocol (TCP/IP) or extensible markup language (XML) to form a network. The communication devices are typically computers, terminals, workstations, or other similar devices capable of receiving and/or sending data with each communication device being capable of residing at vastly different physical locations. The customer, or client, typically refers to a computer utilizing a browser to access information from servers. The server typically comprises a web page which contains information provided to the client in a standard protocol such as Hypertext Markup Language (HTML) or an equivalent thereof. The internet is primarily based on information exchange between servers to clients wherein each has an internet address referred to as a uniform resource locator (URL). The information transmitted utilizes specific protocols which are predetermined and widely accepted, such as HTTP.

The communication links between communication devices are typically, but not limited to, a combination of transmission devices such as optical fibers, coaxial cable, twisted copper pairs or terrestrial signals relayed by satellites and/or antennas. Most commonly the communication link is a wide area network (or “WAN”), such as the internet or world wide web, which uses either public or private switching systems to form the communication linkages between various communication devices. The communication linkage is typically maintained and managed by service providers who provide a communication node whereby clients can link to the computer network through the communication node of the service provider for a predetermined fee.

The servers are preferably a non-volatile storage device which can maintain information with, or without, power. The servers are typically a combination of read-only-memory chips which are unaltered in use and storage media which can be altered by commands from input including the information supplied by the subscriber in the present invention. Particularly preferred servers comprise digital drives. It is common to move information from program storage devices to random-access-memory devices within the server during use to expedite the rate at which calculations or information transmittal occurs. Preferred storage media allow data to be selected from any point on the device such as is common with compact disk technology, magnetic disk technology, random access memory technology and the like. Typical examples include compact disk juke boxes and the like which are commercially available. Sequential data storage techniques such as magnetic tape are less desirable since the access time is longer. Methods enabling the storage of redundant information to protect against loss of service in the event of failure by one storage media are particularly preferred.

Computers, and their use, is well known particularly regarding the applicability of communication over a network by computer. Typically computers comprise a processor, read only memory components, random access components, and input/output devices such as keyboard, mouse, drives, modems etc.

Communication devices, such as modems and hub routers are well known in the industry and further elaboration of the details is not necessary for full disclosure of the invention. A US Robotics 33.6 external modem is particularly well suited for demonstrating the present invention but any modem commonly used to connect a computer to a network is suitable. Hub routers are well known and the choice of a hub router is not limited herein.

The invention has been describe with emphasis directed to the preferred embodiments. It would be apparent from the description herein that various embodiments could be developed without departing from the scope of the invention. Alternate methods of construction, operation and use could also be employed without departing from the scope of the invention which is set forth in the claims which follow.

Claimed is:

1. A method for electronic commerce over a network, said method comprising:
transmitting an order entry data set from a customer to an exchange wherein said order entry data set comprises a product identifier and a product volume;
determining a manufacturer from said product identifier;
transmitting a manufacturer specific order from said exchange to said manufacturer wherein said manufacturer specific order comprises said product identifier and said product volume;
transmitting a product availability request from said manufacturer to a dealer wherein said product availability request comprises said product identifier and said product volume;
transmitting an availability report from said dealer to said manufacturer wherein said availability report comprises a dealer price adjustment;
transmitting a manufacturer confirmation report from said manufacturer to said exchange wherein said manufacturer confirmation report comprises an availability index derived from said availability report and a customer price derived from said dealer price adjustment;
transmitting a product order confirmation from said exchange to said customer wherein said product order confirmation comprises said manufacturers confirmation report;
transporting a product corresponding to said product identifier from said dealer to said customer;
transferring purchase funds from said customer to said dealer wherein said purchase funds correspond to said customer price; and
transferring manufacturer funds from said dealer to said manufacturer.

2. The method for electronic commerce over a network of claim 1 wherein said manufacturer specific order further comprises a customer identifier.

3. The method for electronic commerce over a network of claim 1 wherein said product order confirmation comprises a second manufacturers confirmation report from a second manufacturer.

4. The method for electronic commerce over a network of claim 1 wherein said manufacturers confirmation report further comprises a second availability index derived from a second availability report from a second dealer.

5. The method for electronic commerce over a network of claim 1 wherein said network is a computer network.

6. The method for electronic commerce over a network of claim 5 wherein said computer network is the world wide web.

7. The method for electronic commerce over a network of claim 1 further comprising: transmitting a purchase order from said customer to said exchange prior to said transporting a product.

8. The method for electronic commerce over a network of claim 7 further comprising transmitting a dealer purchase order from said exchange to said dealer.

9. The method for electronic commerce over a network of claim 7 further comprising transmitting a purchase confirmation from said exchange to said manufacturer.

10. The method for electronic commerce over a network of claim 9 further comprising transmitting a dealer purchase order from said manufacturer to said dealer.

11. The method for electronic commerce over a network of claim 1 further comprising a contractual price relationship between said manufacturer and said customer.

12. The method for electronic commerce over a network of claim 11 wherein said customer price is derived from said contractual price relationship and said dealer price adjustment.

13. A system for coordinating product orders and distribution over a network wherein a manufacturer and a customer have a specific contractual price relationship and wherein said system comprises:
a communication device for receiving a manufacturing specific order over said network from an exchange where said manufacturing specific order comprises a product identifier, which identifies a product of said manufacturer, a product volume and a customer identifier which identifies said customer;
a second communication device for transmitting a product availability request to a dealer wherein said product availability request comprises said product identifier and said product volume;
a third communication device for receiving an availability report from said dealer wherein said availability report comprises a dealer availability index for said product and a dealer price adjustment;
a processor for determining a customer price from said contractual price relationship and said dealer price adjustment and an availability index derived from said dealer availability index and a manufacturers inventory;
a fourth communication device for transmitting a manufacturer confirmation report to said exchange wherein said manufacturer confirmation report comprises said customer price and said availability index;
a fifth communication device for receiving a purchase confirmation from said exchange wherein said purchase confirmation comprises products distributed by said dealer.

14. The system for coordinating product orders and distribution over a network of claim 13 further comprising a sixth communication device for transmitting a dealer purchase order to said dealer wherein said dealer purchase order comprises said products distributed by said dealer.

15. The system for coordinating product orders and distribution over a network of claim 13 wherein said communication device and at least one of said group consisting of said first communication device, said second communication device, said third communication device, said fourth communication device, said fifth communication device and said sixth communication device are the same device.

16. The system for coordinating product orders and distribution over a network of claim 15 wherein said communication device; said first communication device; said second communication device; said third communication device; said fourth communication device; said fifth communication device and said sixth communication device are the same device.

17. The system for coordinating product orders and distribution over a network of claim 13 wherein said manufacturer distributes said product to said customer.

18. The system for coordinating product orders and distribution over a network of claim 15 wherein said dealer distributes said product to said customer.

19. The system for coordinating product orders and distribution over a network of claim 15 wherein said network is the world wide web.

20. A system for coordinating product orders and distribution over a network wherein said system comprises a multiplicity of manufacturers, a multiplicity of customers and a multiplicity of dealers and at least one manufacturer of said multiplicity of manufacturers and at least one customer of said multiplicity of customers have a specific contractual price relationship and wherein said system comprises:
a communication device for receiving an order entry data set from said customer wherein said order entry data set comprises at least one product identifier identifying a product manufactured by said manufacturer and at least one product volume and at least one customer identifier;
said communication device further transmits a manufacturer specific order to said manufacturer wherein said manufacturer specific order comprises said product identifier, said product volume and said client identifier;
said communication device further receives a manufacturers confirmation report from said manufacturer wherein said manufacturers confirmation report comprises an availability index for said product and a customer price wherein said availability index is derived from a dealer availability index and said customer price is derived from a dealer price adjustment and said specific contractual price relationship; and
said communication device further transmits a purchase order confirmation to said customer wherein said purchase order confirmation comprises said customer price and said availability index.

21. The system for coordinating product orders and distribution over a network of claim 20 wherein said order entry data set further comprises a second product identifier identifying a second product manufactured by a second manufacturer and a second product volume and wherein said second manufacturer has a second specific price relationship with a second customer;
said communication device further transmits a second manufacturers specific order to said second manufacturer wherein said second manufacturer specific order comprises a second product identifier and a second product volume and said customer identifier;
said communication device further receives a second manufacturers confirmation report from said second manufacturer wherein said second manufacturers confirmation report comprises a second availability index for a second product and a second customer price wherein said second availability index is derived from a second dealer availability index and a second customer price is derived from a second dealer price adjustment and said second specific contractual price relationship; and
said purchase order confirmation comprises said second customer price and said second availability index.

22. A method for coordinating product orders and distribution over a network wherein said network comprises a multiplicity of manufacturers, a multiplicity of customers and a multiplicity of dealers and at least one manufacturer of said multiplicity of manufacturers has a specific contractual price relationship with at least one customer of said multiplicity of customers and wherein said method comprises:
receiving an order entry data set from said customer wherein said order entry data set comprises a product identifier identifying a product manufactured by said manufacturer and a volume and a customer identifier and a second product identifier and a second product volume identifying a second product manufactured by a second manufacturer and wherein said second manufacturer has a second specific price relationship with a second customer;
transmitting a manufacturer specific order to said manufacturer wherein said manufacturer specific order comprises said product identifier, said product volume and said client identifier;
transmitting a second manufacturers specific order to said second manufacturer wherein said second manufacturer specific order comprises a second product identifier and a second product volume and said customer identifier;
receiving a manufacturers confirmation report from said manufacturer wherein said manufacturers confirmation report comprises an availability index for said product and a customer price wherein said availability index is derived from dealer availability index and said customer price is derived
from a dealer price adjustment and said specific contractual price relationship; and
receiving a second manufacturers confirmation report from said second manufacturer wherein said second manufacturers confirmation report comprises a second availability index for a second product and a second customer price wherein said second availability index is derived from a second dealer availability index and a second customer price is derived from a second dealer price adjustment and said second specific contractual price relationship; and
transmitting a purchase order confirmation to said customer wherein said purchase order confirmation comprises said customer price, said availability index said second customer price and said second availability index.

23. A system for coordinating product orders and distribution over a network wherein a manufacturer and a customer have a specific contractual price relationship and wherein said system comprises:
a communication device for receiving a manufacturing specific order over said network from an exchange where said manufacturing specific order comprises a product identifier, which identifies a product of said manufacturer, a product volume and a customer indentifier which identifies said customer;
said communication device further transmits a product availability request to a dealer wherein said product availability request comprises said product identifier said product volume and said customer identifier;
said communication device further receives an availability report from said dealer wherein said availability report comprises a dealer availability index for said product and a dealer price adjustment;
a processor for determining a customer price from said contractual price relationship and said dealer price adjustment and an availability index from said dealer availability index and a manufacturers inventory;
said communication device further transmits a manufacturer confirmation report to said exchange wherein said manufacturer confirmation report comprises said customer price and said availability index;
said communication device further receives a purchase confirmation from said exchange wherein said purchase confirmation comprises products distributed by said dealer.

24. The system for coordinating product orders and distribution over a network of claim 23 wherein said communication device further transmits a dealer purchase order to said dealer wherein said dealer purchase order comprises said products distributed by said dealer.

25. The system for coordinating product orders and distribution over a network of claim 23 wherein said dealer delivers said product to said customer.

26. The system for coordinating product orders and distribution over a network of claim 25 wherein said customer compensates said dealer for said product.

27. A system for coordinating product orders and distribution over a network wherein said network comprises a multiplicity of manufacturers, a multiplicity of customers and a multiplicity of dealers and at least one manufacturer of said multiplicity of manufacturers and at least one customer of said multiplicity of customers have a specific contractual price relationship and wherein said system comprises:
a communication device for receiving an order entry data set from said customer wherein said order entry data set comprises at least one product identifier identifying a product manufactured by said manufacturer and at least one product volume and at least one customer identifier;
said communication device further transmits a manufacturer specific order to said manufacturer wherein said manufacturer specific order comprises said product identifier, said product volume and said client identifier;
said communication device further receives a manufacturers confirmation report from said manufacturer wherein said manufacturers confirmation report comprises an availability index for said product and a customer price wherein said availability index is derived from a dealer availability index and said customer price is derived from a dealer price adjustment and said specific contractual price relationship;
said communication device further receives a purchase order from said customer; and
said communication device further transmits a purchase order confirmation to said customer wherein said purchase order confirmation comprises said customer price and said availability index.

28. The system for coordinating product orders and distribution over a network of claim 27 wherein said system further comprises a catalog server addressable by said client.

29. The system for coordinating product orders and distribution over a network of claim 28 wherein said system further comprises a content rich catalog server addressable by said client.

30. The system for coordinating product orders and distribution over a network of claim 29 wherein said content rich catalog server is addressable by said client through said catalog server.

31. A method for coordinating product orders and distribution over a network wherein a manufacturer and a customer have a specific contractual price relationship and wherein said method comprises:
receiving a manufacturing specific order over said network from an exchange where said manufacturing specific order comprises a product identifier, which identifies a product of said manufacturer, a product volume and a customer indentifier which identifies said customer;
transmitting a product availability request to a dealer wherein said product availability request comprises said product identifier said product volume and said customer identifier;
receiving an availability report from said dealer wherein said availability report comprises a dealer availability index for said product and a dealer price adjustment;
determining a customer price from said contractual price relationship and said dealer price adjustment and an availability index from said dealer availability index and a manufacturers inventory;
transmitting a manufacturer confirmation report to said exchange wherein said manufacturer confirmation report comprises said customer price and said availability index; and
receiving a purchase confirmation from said exchange wherein said purchase confirmation comprises products distributed by said dealer.

32. The method for coordinating product orders and distribution over a network of claim 31 further comprising transmitting a dealer purchase order to said dealer wherein said dealer purchase order comprises said products distributed by said dealer.

33. A method for coordinating product orders and distribution over a network wherein said network comprises a multiplicity of manufacturers, a multiplicity of customers and a multiplicity of dealers and at least one manufacturer of said multiplicity of manufacturers and at least one customer of said multiplicity of customers have a specific contractual price relationship and wherein said method comprises:
receiving an order entry data set from said customer wherein said order entry data set comprises at least one product identifier identifying a product manufactured by said manufacturer and at least one product volume and at least one customer identifier;
transmitting a manufacturer specific order to said manufacturer wherein said manufacturer specific order comprises said product identifier, said product volume and said client identifier;
receiving a manufacturers confirmation report from said manufacturer wherein said manufacturers confirmation report comprises an availability index for said product and a customer price wherein said availability index is derived from a dealer availability index and said customer price is derived from a dealer price adjustment and said specific contractual price relationship;
receiving a purchase order from said customer; and
transmitting a purchase order confirmation to said customer wherein said purchase order confirmation comprises said customer price and said availability index.
